(19) United States
(12) Patent Application Publication
(10) Pub. No.: US 2013/0037662 A1
(43) Pub. Date: Feb. 14, 2013

(54) SNORKEL HOLDER APPARATUS

(71) Applicant: Kai Skudelny, Appiano sulla Strada del Vino (IT)

(72) Inventor: Kai Skudelny, Appiano sulla Strada del Vino (IT)

(21) Appl. No.: 13/640,580

(22) PCT Filed: Apr. 13, 2011
(86) PCT No.: PCT/EP2011/055778

§ 371 Date: Nov. 5, 2012

(30) Foreign Application Priority Data
Apr. 15, 2010 (IT) BZ2010A000014

(51) Int. Cl. F16L 3/10

(52) U.S. Cl. 248/75

(57) ABSTRACT

A supporting device for a snorkel is described, comprising a fixing element for a diving mask strap.

According to the invention, the fixing element is formed by a clip (1) suitable for being fixed to a tubular portion of a snorkel and by a clip (2) suitable for being fixed to a diving mask strap, the clips (1, 2) being provided with connectors (5, 11) suitable for coming into contact with each other, each connector (5, 11) featuring a magnetic property for mutual attraction of the two clips.

The present invention refers to a supporting device for a snorkel according to the pre-characterizing portion of claim 1.

The use of snorkels is common for underwater swimming. The snorkel may be self-standing or connected to the swimmer's neck or to the diving mask. In the latter case, the snorkels are releasably connected with a strap to the mask. This way of fixing does not always provide for an easy mounting and unmounting of the snorkel, especially if one wants to remove the snorkel in order to wear it without the mask.

The aim of the present invention is that of realizing a method of mounting and unmounting which is quick and easy either during snorkel operation and when the snorkel is not in use, ensuring that during operation both modes of carrying the snorkel connected to the mask or independently from the mask are allowed.

This aim is achieved by a snorkel supporting device according to the characterizing portion of claim 1.

By proposing a clip for a mask strap and a separate clip embracing the snorkel on its straight portion, both clips can be attracted toward each other by respective magnetic plates, or by a magnetic plate and a ferromagnetic one, which are housed in a connector of the respective clip in such a way that the plates may oppose each other.

In a preferred embodiment the clip connector for the snorkel is opposed to the opening of the clip. On the other hand, the clip connector suitable for being mounted on the mask strap is next to the clip opening, i.e. an arm of the clip is formed by the connector.

In an alternative embodiment the connectors respectively feature a housing suitable for housing a magnetic plate, or respectively a ferromagnetic plate, in such a way as to be closed at the insertion side by means of a closing element.

Further features and advantages will emerge from the claims and from the following description of a preferred embodiment, shown in the annexed drawings, wherein:

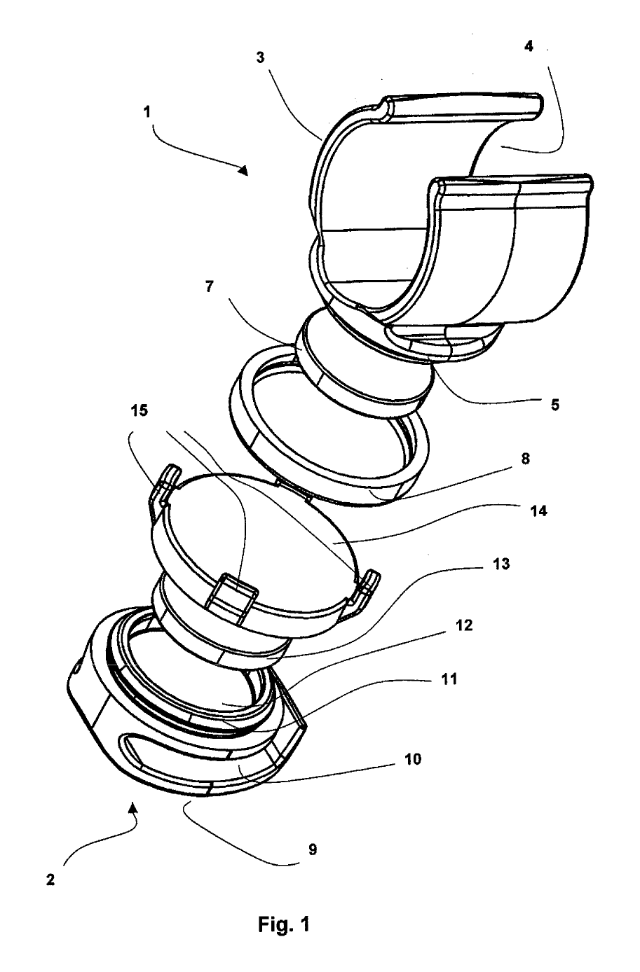

FIG. 1->shows an exploded perspective view of a supporting device according to the invention,

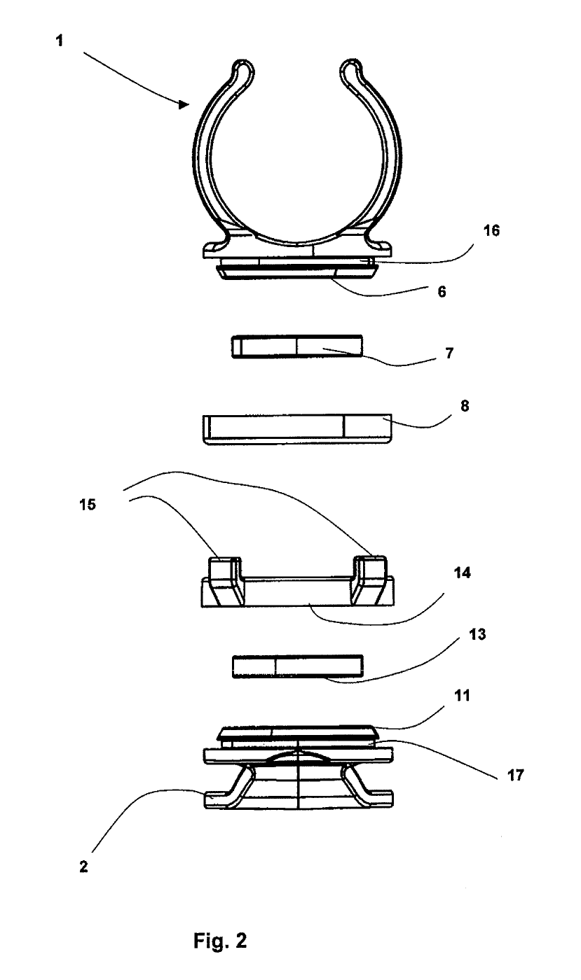

FIG. 2->shows a perspective view of the supporting device according to the invention mounted on a mask strap and on a snorkel,

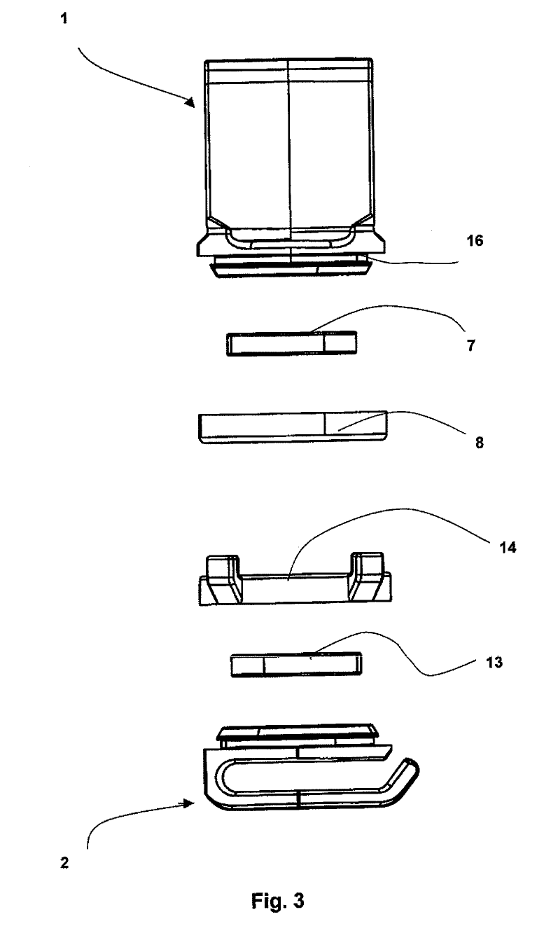

FIG. 3->shows a longitudinal section rotated by 90° with respect to FIG. 2.

A snorkel supporting device according to the invention is shown in the figures, being formed of a clip 1 suitable for being mounted on a tubular portion (not shown) of a snorkel and by a clip 2 suitable for being mounted on a diving mask strap.

The snorkel clip 1 features a partially circular band 3 with an opening 4 for snap-fitting of the tubular portion of a snorkel. Opposite to the opening 4, a connector 5 features a housing suitable for housing a magnetic plate 7 with substantial form fit. Advantageously the housing 7 may be closed by an element 8 to be welded on the portion 5.

On the other hand, the mask clip 2 is formed by a hook 9 featuring an opening 10 for housing a strap. Next to the opening 10 a connector 11 is placed, which features a housing 12 suitable for housing a magnetic plate 13 with a substantial form fit. The opening of the housing 12 may be advantageously closed by means of a closing element 14 to be welded on the flat portion.

Due to the magnetic attraction between the plates, the clips may be joined in a releasable manner either for holding the snorkel to the mask (either during operation or when not in use) and for detaching the snorkel from the mask (either during operation or when not in use).

In order to prevent a relative displacement of the closing elements 8 and 14, one 14 of them is provided with gripping teeth 15 on its perimeter so as to hold the other closing element 8.

As an alternative to welding, the connector 11 may be provided with an undercut 16 for snap-fitting of the closing element 8 and the connector 11 may be provided with an undercut 17 for snap-fitting of the closing element 14.

### LIST OF REFERENCE NUMBERS

1 clip

2 clip

3 circular band

4 opening

5 connector

6 housing

7 magnetic plate

8 closing element

9 hook

10 opening

11 connector

12 housing

13 magnetic plate

14 closing element

15 gripping tooth

16 undercut

17 undercut

1. A supporting device for a snorkel, comprising a fixing element for a diving mask strap, characterized in that the fixing element is formed by a clip suitable for being fixed to a tubular portion of a snorkel and by a clip suitable for being fixed to a diving mask strap, the clips being provided with connectors suitable for coming into contact with each other, each connector featuring a magnetic property for mutual attraction of the two clips.

2. The supporting device according to claim 1, characterized in that the snorkel clip features a partially circular band with an opening for snap-fitting of the tubular portion of a snorkel, the connector being opposed to the opening and featuring a housing suitable for housing a magnetic plate with a substantial form fit.

3. The supporting device according to claim 1, characterized in that each connector features a housing in which the magnetic plates or the magnetic and ferromagnetic plates are respectively housed, the housings being closable by closing elements.

4. The supporting device according to claim 2, characterized in that the housing is closed by a closing element connectable with the connector.

5. The supporting device according to claim 1, characterized in that the diving mask clip is formed by a hook featuring an opening for housing a diving mask strap, a connector, featuring a housing suitable for housing a magnetic plate with a substantial form fit, being placed next to the opening.

6. The supporting device according to claim 3, characterized in that in order to prevent a relative displacement of the closing elements, one of them is provided with gripping teeth on its perimeter so as to hold the other closing element.

7. The supporting device according to claim 3, characterized in that the closing elements are respectively welded to the connectors.

8. The supporting device according to claim 3, characterized in that the connector is provided with an undercut for snap-fitting of a closing element and the connector is provided with an undercut for snap-fitting of the closing element.
